(19) United States
(12) Patent Application Publication
(10) Pub. No.: US 2002/0010865 A1
(43) Pub. Date: Jan. 24, 2002

(54) METHOD AND APPARATUS FOR REMOTE OFFICE ACCESS MANAGEMENT

(76) Inventors: CHRISTINA E. FULTON, CHICAGO, IL (US); RANDOLPH REITZ, WHEATON, IL (US); JEFFREY MULTACH, LAKE IN THE HILLS, IL (US)

Correspondence Address: BRINKS HOFER GILSON & LIONE, P.O. BOX 10395, CHICAGO, IL, 60610, US

(21) Appl. No.: 09/239,843

(22) Filed: Jan. 29, 1999

Related U.S. Application Data
(60) Provisional application No. 60/073,072, filed on Jan. 30, 1998.

(51) Int. Cl. H04L 12/22

(52) U.S. Cl. 713/201; 713/155; 709/229

(57) ABSTRACT

A method for remote office access management. A remote user dials a number associated with a remote office access server. A connection is established between the user and the remote office access server. A first packet containing user identification information is passed from the remote office access server to a security server. The security server authenticates the user information. If access is granted, the security server returns the authentication decision to the remote office access server and data is permitted to pass between the user and a customer network. The customer network is typically a LAN.

### RELATED APPLICATION

This application claims the benefit of U.S. Provisional Application No. 60/073,072, filed on Jan. 30, 1998.

### BACKGROUND

The present invention relates to remote computing and, more particularly, to a method and apparatus for remote office access management.

Business is no longer conducted merely within the strict limits of a traditional office space. Communications technology has helped business to surmount this barrier. Work that used to be done only behind a desk or at a workstation is now more frequently done on the road, in the air, at home and in a multitude of other locations.

This growing off-site workforce frequently utilizes dial-up connections to a local area network (LAN), which is typically located back at the office. A number of issues arise from the desire to accommodate the off-site workforce by providing remote access. First, there is a connectivity issue: the off-site worker may be trying to obtain remote access using plain old telephone service (POTS), ISDN or cellular method. Another major issue is security. In addition to preventing unauthorized users from obtaining remote access, it is frequently important to monitor remote access by authorized users. Known methods and apparatii for remote office access management are typically hardware intensive and may demand substantial administrative resources.

It is therefore desirable to provide a method and apparatus for remote office access management.

### BRIEF DESCRIPTION OF THE FIGURES

FIG. 1 is a schematic diagram of a network for connecting a remote use to a customer LAN using remote office access management.

FIG. 2 is a diagram of a remote office access manager POP network design in which a fireall is located in the remote office access manager POP.

FIG. 3 is a diagram of a remote office access manager POP network design without a firewall.

FIG. 4 shows user traffic flow through a remote office access management POP having a firewall.

FIG. 5 illustrates admin/report traffic flow for the network shown in FIG. 2.

FIG. 6 shows traffic flow to the security server shown in FIG. 2.

FIG. 7 shows traffic flow to a backup security server.

FIG. 8 shows traffic flow to a communication service provider's security server.

FIG. 9 shows traffic flow for maintenance and monitoring traffic.

FIG. 10 shows traffic flow for security server database backup.

FIG. 11 shows user admin/report client traffic flow from a non-firewall POP.

FIG. 12 shows AAA traffic flow to the primary security server from a non-firewall POP.

FIG. 13 shows traffic flow for maintenance and monitoring traffic from a non-firewall POP.

FIG. 14 illustrates an alternative apparatus for remote office access management in which a security server is installed at the customer's premises.

FIG. 15 shows a customer premises installation in which security function are performed by a communication server provider.

FIG. 16 shows a customer premise installation that utilizes a remote office security server.

FIG. 17 shows an apparatus for remote office access management in accordance with the present invention.

FIG. 18 shows an internal diagram of the remote office access server.

FIGS. 19, 20 and 21 illustrate examples of possible uses of an aggregation router in a remote office access management system.

### DETAILED DESCRIPTION OF THE PRESENTLY PREFERRED EMBODIMENTS

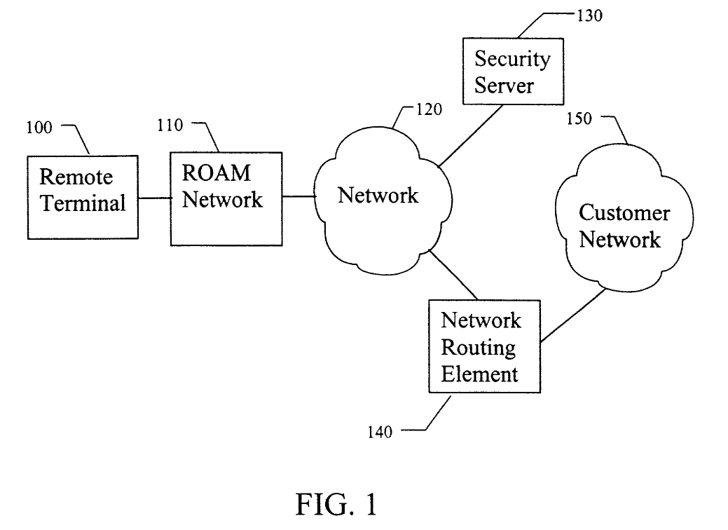

The preferred embodiments of the present invention will now be described with reference to the drawings, in which like elements are referred to by like numerals. FIG. 1 is a block diagram of an apparatus for remote office access management. The customer at a remote location utilizes a remote computing terminal 100 to connect to a first network 110. The first network 110 is connected to a second network 120. Network 120 is preferably a Frame Relay network or Switched Multimegabit Data Service (“SMDS”) network, but may also be, e.g., an Asynchronous Transfer Mode (“ATM”) network. Network 120 is connected to a security server 130 and to a network routing element 140. Network 110 passes the initial data, typically including user identification information, from the remote terminal 100 to the security server 130 via the network 120. The security server 130 examines the user information within the packet and verifies it in accordance with predetermined authentication procedures. Server 130 then transmits the verified (or rejected) packet back to network 120. If authenticated by the server 130, network 120 passes the data to network routing element 140 for routing to an appropriate customer network 150. The customer network 150 typically interconnects mainframe computing devices, as well as various server computers operating under Novell, Windows NT, or Unix operating systems

Types of Remote Office Access Management Points of Presence (POPs)

Each remote office access manager POP preferably has a remote office access manager security server and access to a backup security server. As further described below, the remote office access manager user will use one or both (with the remote office access manager security server acting as a proxy) of these security servers to support a centralization mechanism, such as TACACS+AAA (Authentication, Authorization and Accounting), for accessing a customer database. The TACACS+AAA support is preferred for the remote office access manager method since several important features of this method (such as SecurID token authentication and remote office access manager reports) can not be provided without using a security server. The remote office access manager security server and the backup server are preferably shared among all remote office access manager users and are therefore part of the remote office access manager infrastructure.

For cases in which the security servers are shared, the security servers are protected with a firewall. The location of the firewall is likely to be in the remote office access manager POP, hence two remote office access manager POP network designs may be utilized.

Dedicated security servers could alternatively be used, although with a concomitant increase in hardware overhead and administration expense. In this case, there is a customer premise option for the remote office access manager that also uses a security server. The security server in the remote office access manager customer premise solution will likely be located on the customer's premise.

Firewall POP

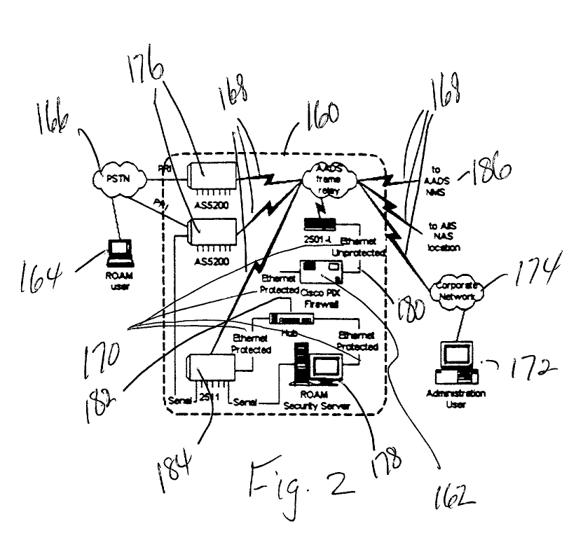

The diagram in FIG. 2 shows the remote office access manager POP network 160 design when a firewall 162 is located in the remote office access manager POP 160. A remote user 164 is connected through the public switched telephone network 166 to the remote office access manager POP network 160. There are several frame relay links 168 and ethernet networks 170 in this diagram. The frame relay links in FIG. 2 are shown as lighting bolts. An administration user 172 on a corporate network 174 is also connected to the remote office access manager POP network 160.

As shown in FIG. 2, a remote office access server(s) 176 is dedicated to a predetermined users' remote office access manager POP 160. The remote office access server(s) 176 is considered, for security purposes, to be connected to untrusted networks. Therefore, traffic from the access servers 176, such as TACACS+AAA packets, must pass through the firewall 162 before terminating on a security server 178. Also, user administration TACACS+ packets must pass through the user's dedicated remote office access server 176 and then find the same route to the security server 178.

In the illustration of FIG. 2, there are two ethernet networks associated with this POP. The “unprotected” network 180 attaches the frame relay circuit to the unprotected side of the firewall 162. The “protected” network 182 connects the firewall 162 to the remote office access management security server 178. The remote office access management security server 178 is also connected to a communication server 184. This provides a path for the POP's remote office access servers 176 to locate their backup security server. The ethernet path to the communication server 184 also allows the remote office access management security server 178 to find the master backup security server. The remote office access manager security server 178 preferably has connectivity to the master backup server (not shown) for database backup purposes. The communication service provider's network management system, such as Ameritech's AADS NMS network 186, is used to complete these connections.

The remote office access server 176 may be an AS5200 Universal Access Server from Cisco Systems, Inc., which is configured as described below. The firewall 162 may be a Cisco PIX, also from Cisco Systems, Inc. The communication server 184 preferably has multiprotocal routing capability between synchronous serial, LAN, and asynchronous serial ports, such as is provided by the Cisco 2511 Access Server. Alternative hardware may also be used provided that it supports the functions described above.

Non-Firewall POP

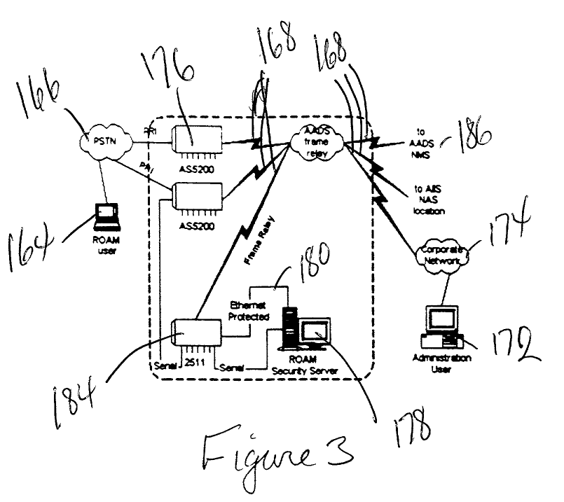

The diagram in FIG. 3 shows the remote office access manager POP network design without a firewall. This diagram is similar to FIG. 2, except that the firewall and the unprotected ethernet networks have been removed.

User Specific Permanent Virtual Circuits (PVCs)

A PVC is a permanent association between data terminals that is established by configuration. Each remote office access server 176 typically includes one frame relay circuit to be provisioned with three PVCs as follows:

TABLE 1
User specific PVCs
PVCs from remote office access server

| PVC-Destination | Description |
|---|---|
| PVC#1 - to user's LAN | Extend user's LAN to remote office |
| | and beyond to remote user |
| PVC#2 - to primary security | Handle all TACACS + AAA traffic |
| server, either remote office | |
| access manager security server | |
| or AIsecurity server NAS | |
| PVC#3 - to backup security server | Handle all TACACS + AAA traffic |
| | when primary security server doesn't |
| | respond |

Remote Office Access Management Infrastructure PVCs

There are several frame relay circuits and PVCs that are put in place within the remote office access management infrastructure.

TABLE 2
Infrastructure Frame Relay Circuits

| FR Circuit | PVC Location | Description |
|---|---|---|
| router-u | in remote office | Handle all TACACS + AAA |
| | access manage- | traffic for predetermined geographic |
| | ment POP with | area |
| | firewall | |
| communication | in remote office | Handle all TACACS + AAA |
| server | access manage- | traffic to backup security server |
| | ment POP | site; handle all remote officer |
| | | access manage maintenance |
| | | traffic |
| Method FR | in remote office | Handle all remote office access |
| switch | access manage- | manager security server |
| | ment POP | backup traffic (i.e. FTP traffic); |
| | | handle all remote office access |
| | | manager maintenance traffic |

The three frame relay circuits described in Table 2 will have multiple PVCs provisioned. A full mesh may be needed. For example, the router (the U is for unprotected) frame relay circuit will have one PVC for each remote office access server 176 that needs to access the remote office access management security server 178. These PVCs will be used for TACACS+AAA traffic to the primary remote office access management security server 178 and to the backup remote office access manager security server. There will preferably be two firewalls per predetermined geographic area (e.g. state) so that their will be two remote office access management POPS per state, each with a router and its associated frame relay circuit. A network connects each remote office access server 176 to a primary router and to a secondary router within the predetermined geographic area.

The remote office access management POP's communication server 184 is considered to be on the “protected” network. Each remote office access management POP's communication server 184 will need a path to other communication servers in the same geographic area and to the communication service provider's network management system. If the primary remote office access management security server 178 fails to respond, the associated remote office that originated the AAA request will generate another request that is addressed to the backup remote office access manager security server. This traffic will travel to the router, through the firewall out the communication server 184 to a communication server 184 in the POP with the backup security server and finally into the protected ethernet to the backup security server.

Remote Office Access Management Backup Security Server

There are two types of security server backups. From the point of view of the remote office access server, two security server IP addresses are configured into the remote office access server, such as the server(s) 176. This allows the remote office access server 176 to try the other (i.e. backup) security server if the first (i.e. primary) fails to respond in the allotted time.

Backing up the data on each security server is another matter. The communication service provider may make available a “master” remote office access management security server that can be used by each POP remote office access management security server for database backup purposes.

Traffic Flow in Firewall POP

The networks in FIG. 2 and FIG. 3 are complete; but it helps to trace the traffic flow to understand the infrastructure requirements. This discussion is for a remote office access management POP that contains a firewall, as shown in FIG. 2. For a remote office access manager POP without a firewall, the flows are similar with the exception that some flows must travel to the firewall in another POP and then return to the security server in the local POP. The following traffic flows will be described.

1. User Data Traffic

2. User remote office access manager security server Administration/Report Traffic

3. AAA to Primary remote office access manager Security Server

4. AAA to Backup remote office access manager Security Server

5. AAA to communication service provider

6. Maintenance and Monitoring Traffic (SNMP, TELNET, SYSLOG and TFTP)

7. remote office access manager Security Server Backup

User Data Traffic

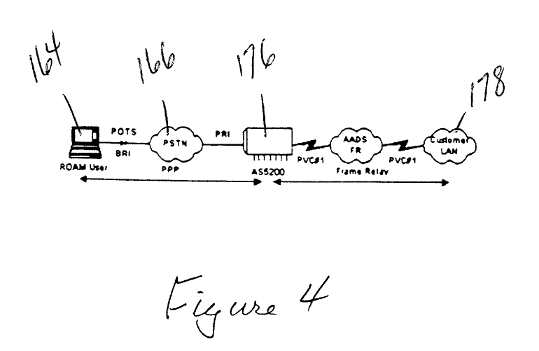

FIG. 4 shows traffic flow through a remote office access management POP having a firewall. The remote office access server 176 converts level 2 point-to-point protocol (PPP) traffic to frame relay format for delivery to the remote office access management user's LAN 178. A PVC (PVC #1 in Table 1) is dedicated to the user traffic for each remote office access server 176 that is required to supply the number of lines that the remote office access management user requires.

User Remote Office Access Management Security Server Administration/Report Traffic

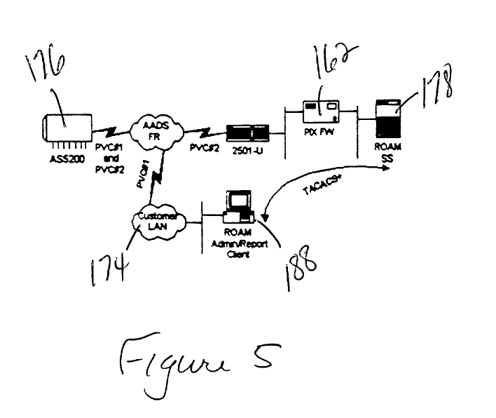

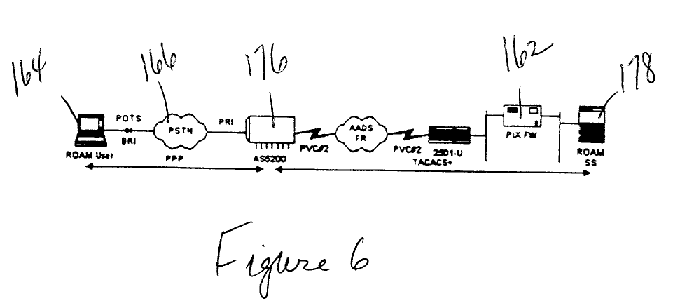

FIG. 5 shows administration/report traffic flow for the network shown in FIG. 2. The remote office access management security server 178 includes Administration/Report client application software 188, available from Ameritech, that allows the remote office access management user to administer their security server accounts and to generate remote office access management reports on demand. The remote office access manager Admin/Report client application software 188 runs on the user's PC, connected to the customer LAN 174, and uses TACACS+to communicate with the security server 178. The diagram in FIG. 5 shows that packets generated by the remote office access manager Admin/Report client 188 travel over the user's LAN 174 back to the remote office access server 176 over PVC#1 and then take PVC#2 out of the remote office access server 176 to the security server 178. Traffic flow over PCV#2 is described in FIG. 6 below. The firewall 162 is configured to pass TACACS+ traffic. The IP addresses used for the TACACS+ traffic generated by the remote office access management Admin/Report client 188 are out of the remote office access management user's address space. The security server 178 is configured with secondary addresses for each user it serves. Hence the firewall 162 must allow all TACACS+traffic to pass, regardless of its source IP address.

AAA to Primary Remote Office Access Management Security Server

FIG. 6 shows AAA traffic flow to the primary security server 178. For the remote office access manager POP with a firewall, the security server 178 in each POP is the primary server for the remote office access servers 176 in the POP. FIG. 6 shows that the authentication, authorization and accounting (AAA) required for the traffic is routed to the security server 178 using TACACS+ protocol. A PVC (PVC#2 in Table 1) is dedicated to the AAA traffic for each remote office access server 176 installed in the POP. The IP addresses used for the TACACS+ traffic are supplied out of the communication service provider's address space.

AAA to Backup Security Server

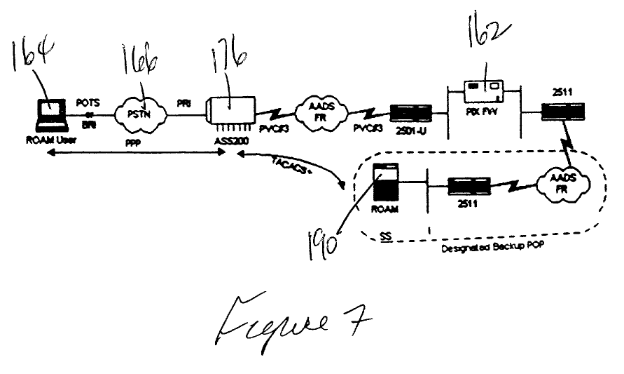

In FIG. 7, for the authentication, authorization and accounting traffic generated by the remote office access server 176 serving the PPP link, the packets must find their way to the backup security server 190 via an infrastructure PVC set up and maintained by the communication service provider. The infrastructure PVC (discussed in Table 2) connects the communication servers between the POPs. The IP addresses used for the TACACS+ traffic are supplied out of the communication service provider's address space.

AAA to Communication Service Provider Security Server

This scenario is the same as FIG. 6. The authentication, authorization and accounting required for the PPP traffic is routed to the communication service provider using TACACS+protocol. A PVC (PVC#2 in Table 1) is dedicated to the AAA traffic for each remote office access server 176 installed in the POP. The IP addresses used for the TACACS+traffic are supplied out of the communication service provider's address space.

Maintenance and Monitoring Traffic—SNMP, TELNET, SYSLOG and TFTP

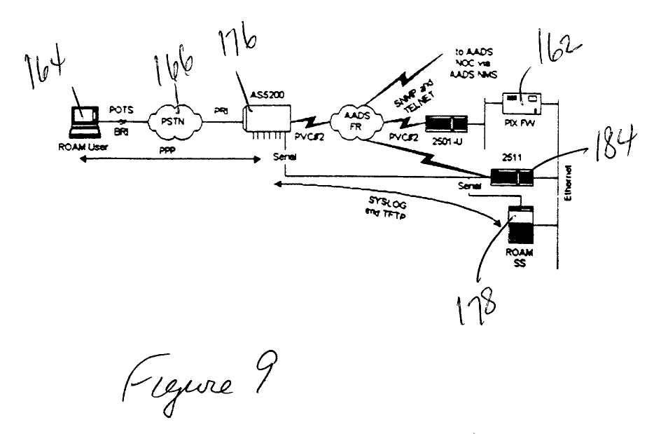

There are two main features in this traffic that are highlighted in FIG. 9. First, the route between the remote office access server 176 and the primary security server 178 will be used for SYSLOG and TFTP traffic. This route uses PVC#2 in Table 1. Therefore, the firewall 162 is configured to pass this traffic. Next, the frame relay circuit to the POP's communication server 184 may be used for maintenance and monitoring traffic (SNMP and TELNET). The SNMP traffic generated (supplied) by the remote office access server 176 will have to travel through the firewall 162 to the communication server 184 for a route back to the communication service provider's network management system location. Telnet traffic from the communication service provider's networks operations center can go directly to the POP's communication server 184 without first traversing the POP's firewall 162. The serial links to the desired equipment can be used for maintenance and non-SNMP monitoring. The route back to the network management system location uses the remote office access management infrastructure communication server 184 PVC in Table 2. Finally, all the maintenance and monitoring traffic travel back to the communication service provider's networks operations center via a frame relay circuit. It is assumed that this frame relay circuit exists at each POP and that a PVC will be provisioned for the communication server 184.

Security Server Database Backup

In the final scenario, the remote office access management security servers 178 need to backup their user databases daily. This will provide a daily copy of the user database on the designated backup security server 190. Also, all of the security servers 178, 190 preferably backup their user database with a master security server 192. File Transfer Protocol (“FTP”) may be used to transfer the user database files. Since all the security servers 178, 190, 192 are on the “protected” network, there are no firewalls involved in these transactions.

Traffic Flow in Non-Firewall POP

The firewall design set forth herein assumes two firewalls per predetermined geographic area. Two firewalls provide a backup in the event one firewall should fail. In the event of a link failure (i.e. a firewall failure), the traffic may be re-routed using a routing protocol to adjust a routing table in response to such failures. In addition, a routing protocol may be used in the remote office access server 176 to handle TACACS+ and SYSLOG traffic that must pass through a firewall. The previous scenarios will now be discussed for traffic flow in a non-firewall POP, such as the POP shown in FIG. 3.

User Data Traffic

User data traffic is not affected by the presence or absence of a firewall in the remote office access management POP. The diagram in FIG. 4 applies to this case.

User Security Server Administration/Report Traffic

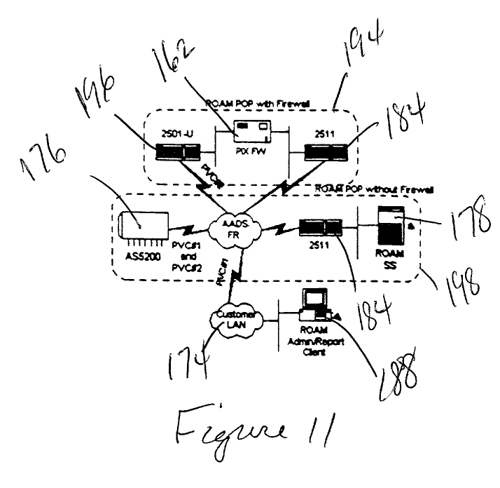

The TACACS+ data packets generated by the remote office access management Admin/Report Client 188 for a customer server out of a non-firewall remote office access management POP follow the route shown by the dotted line in FIG. 11. Using PVC#1, the packets travel back to the remote office access server 176. From there the packets take PVC#2 to the remote office access management POP with a firewall 194. Then the packets travel the remote office access management infrastructure PVCs back to the original POP and then to the serving security server 178.

AAA to Primary Security Server

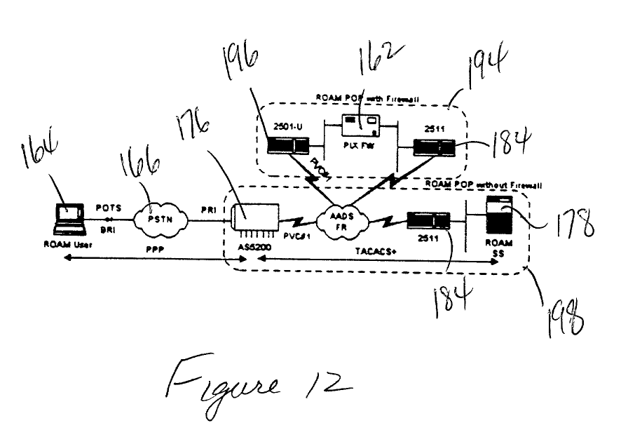

The diagram in FIG. 12 is similar to the diagram in FIG. 6. The difference is that the firewall 162 is in a different POP, i.e. the POP 194. The PVC#1 points to a router 196 in the designated remote office access management firewall POP 194. The traffic on the protected side of the firewall 162 finds its way back to the serving POP 198 via the infrastructure PVC(s).

AAA Backup Security Server

The diagram in FIG. 7 applies in this case. The traffic leaves the original POP to find the backup security server 190. The firewall used will have to be in the designated backup POP. That is, each designated backup POP for the remote office access management security server 178 is a firewall POP 194.

AAA to Communication Service Provider

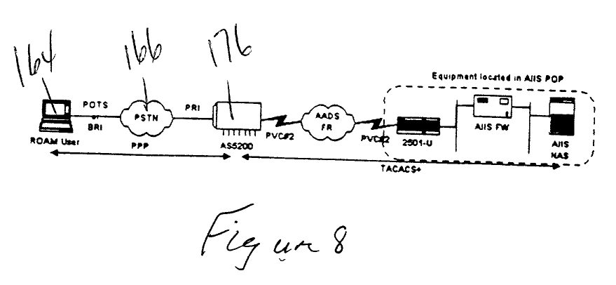

The diagram in FIG. 8 applies in this case.

Maintenance and Monitoring Traffic—SNMP, TELNET, SYSLOG and TFTP

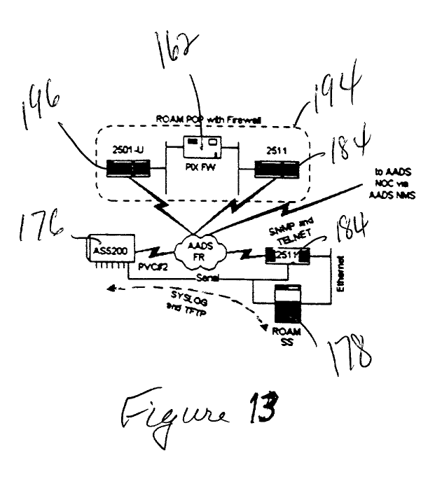

As in FIG. 9, the route between the remote office access server 176 and the primary security server 178 (PVC#2 in Table 1) will be used for the SYSLOG and TFTP traffic. This traffic flow is shown in FIG. 13 by the dotted line. The traffic travels to the designated firewall POP 194 and then back to the original POP and to the remote office access manager security server 178. The infrastructure frame relay circuit from the communication service provider's networks operation center will be used to monitor and administer the remote office access server 176 and the security server 178. The SNMP traffic from the remote office access server 176 will have to travel through the designated firewall 162. Telnet traffic from the communication service provider's networks operations center can go directly to the POP's communication server 184 and then over the serial connections to the desired equipment.

Security Server Database Backup

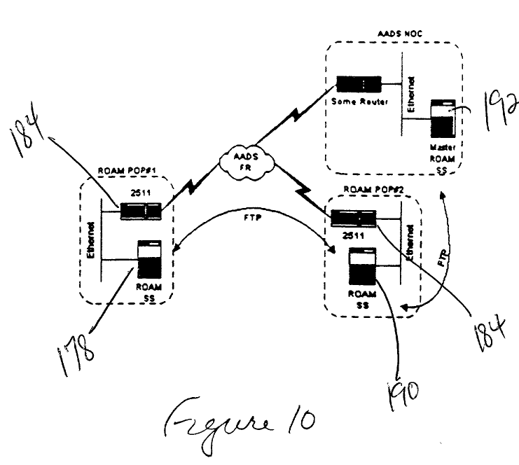

The diagram in FIG. 10 applies in this case. Since the remote office access manager security servers are on the protected side of the firewall(s), no firewalls are needed in the database backup flows.

Remote Office Access Management Customer Premise Alternative

In an alternative embodiment of the present invention, the remote office access server is located at the customer's premises instead of a central office. The remote office access manager customer premise alternative provides a lower cost remote office access management method. The lower service cost is derived from locating the remote office access server on the customer's premise rather than in the communication service provider's switch room. This saves the cost of the floor space loading and the high-speed frame relay circuit between the communication service provider's switch room and the customer site. A low speed frame relay circuit may be used to monitor and administer the remote office access server on the customer premise. The network design for this alternative depends on the security server option the user selects.

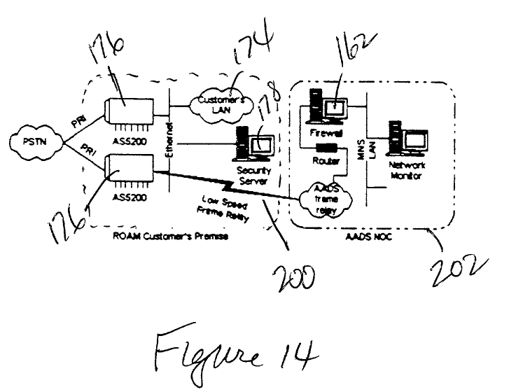

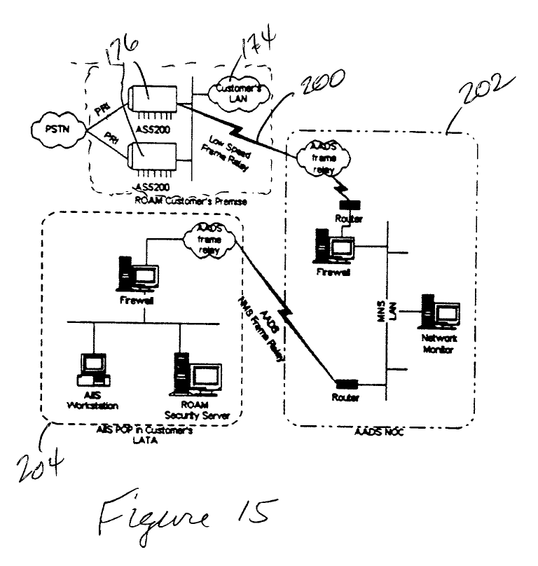

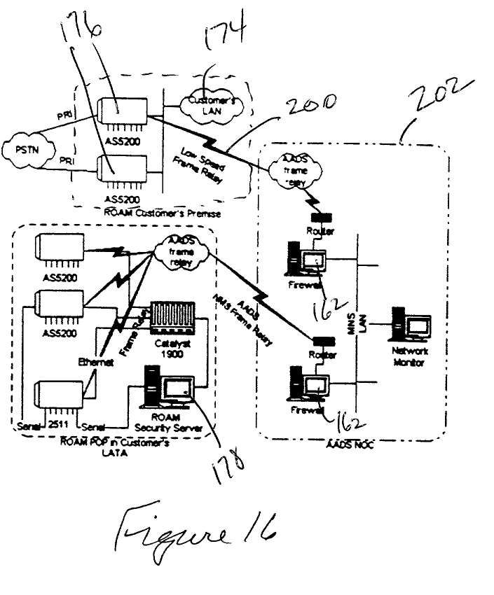

For this embodiment, three alternative security measures may be utilized. First, a security server may be installed at the customer premises. FIG. 14 is a network diagram for this security alternative. Second, the security function may be performed at the communication service provider's networks operations center, which may be connected to the customer premises equipment by a low-speed frame relay link as shown in FIG. 15. Third, a remote office security server may be utilized as shown in FIG. 16. These alternative security measures will now be described.

Customer Premise Security Server Option

The diagram in FIG. 14 shows how the network for the first security alternative is connected. This alternative provides the advantage of being comparatively simple in design.

A low-speed frame relay link 200 allows the communication service provider's networks operations center 202 to provide monitoring and network management functions for the equipment installed on the customer's premise. Authentication requests from the remote office access server 176 are routed over the LAN 174 to a security server 178 that is also located on the customer premise. The local security server 178 handles the authentication requests with the lowest possible delay. A firewall 162 is used in the communication service provider's networks operations center 202 to prevent any user LAN traffic from “leaking” into the NMS LAN.

Static routes in the remote office access server(s) 176 allow the monitoring packets from the NMS LAN to have a route back to the NMS LAN. Part of the NMS LAN can be configured on ethernet so that the security server 178 can be accessed.

Networks Operations Center Alternatives

A slightly more complicated network design is required when the security function is performed at the networks operations center. The diagram in FIG. 15 shows how the network for this security alternative is connected.

In this network design, a low-speed frame relay link 200 between the user premise and the communication service provider's networks operations center 202 is used for monitoring and management functions for the equipment installed on the customer's premise. In addition, the low-speed frame relay link 200 is used to transmit authentication requests from the remote office access server 176 to the communication service provider 204. These authentication requests are sent over the NMS network to the communication service provider location serving the user's geographical region (LATA).

The communication service provider 204 has an IP address that is on the NMS LAN. Static routes in the remote office access server 176 are needed to allow packets addressed to the communication service provider 204 to find their way into the NMS LAN. The latency introduced into authentication packet transit time is affected by the traffic volume on the NMS LAN.

Remote Office Access Management Security Server Option

The diagram in FIG. 16 shows how the network for this security alternative is connected. As in the other two alternatives, a low-speed frame relay link 200 allows the communication service provider's networks operations center 202 to provide monitoring and network management functions for the equipment installed on the customer's premise. Authentication requests (and authorization and accounting packets) from the remote office access server(s) 176 are routed over the low-speed frame relay link 200 onto the NMS LAN. From the NMS LAN these packets find their way to the remote office access management security server 178. The IP address of the security server 178 is the same IP address that is assigned for the communication service provider's networks operations center monitoring and management functions. It is likely that each packet will pass through at least one firewall 162.

In the following sections the configuration of the remote office access server 176 is described.

In the most general sense, an access server is a device used to connect terminals, modems, microcomputers, and networks (for example, SOHO routers) via ISDN to local-area networks and wide area networks. The access server may provide terminal methods, remote node services and protocol translation services. The remote office access management method and apparatus provide the “remote node” connection service. A protocol translation service may be required to handle asynchronous data over ISDN connections via Recommendation V.120 encapsulation and a terminal service may be required to handle security login. The remote office access manager described herein requires one or more remote office access servers to provide the remote node connection functions.

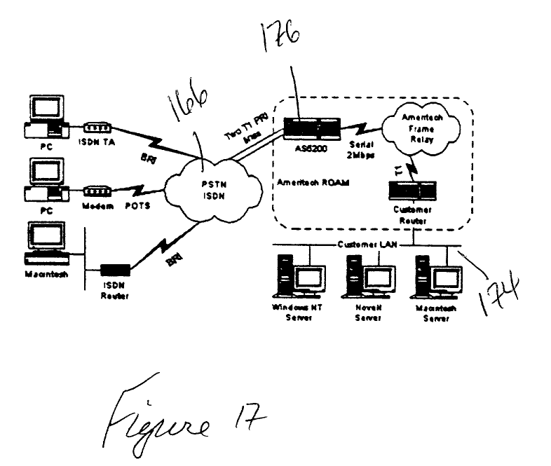

FIG. 17 is a diagram of an apparatus for remote office access management. A security server is preferably also used, but is not shown in FIG. 17.

The area of the diagram in the dashed rectangle is the equipment that is used to provide remote office access management. Although FIG. 17 shows only one remote office access server 176, several remote office access servers 176 can be stacked to provide a user with more than the 46 (48 with channelized T1 and no ISDN) ports provided by a single remote office access server 176. The remote office access management clients are PCs and Macintosh computers that use IP, IPX and/or Apple Talk protocol to communicate with the servers on the “customer LAN” 174. The IP, IPX and Apple Talk protocols may be encapsulated using the Point-to-Point (PPP) protocol to traverse the PSTN to the remote office access server 176. Apple Talk may alternatively be carried in the ARA (Apple Talk Remote Access) protocol. The remote office access server 176 accepts calls from the clients, authenticates users and terminates the PPP or ARA link. The remote office access server 176 uses a frame relay service, such as the Ameritech Frame Relay Service, to connect to the user's LAN 174 and deliver packets that were encapsulated in PPP or ARA.

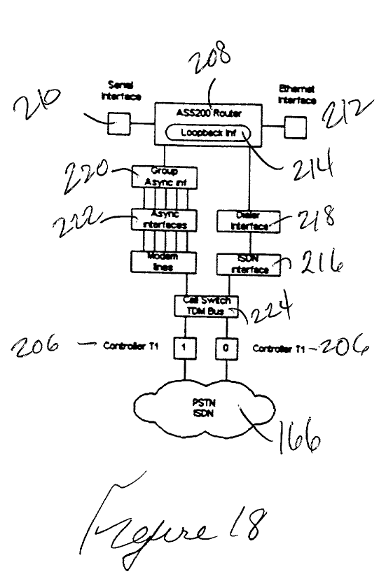

FIG. 18 shows an internal diagram of the remote office access server 176. As shown, the remote office access server 176 is an ISDN-capable access server that can originate and receive ISDN and analog calls from remote clients needing access to network resources. The remote office access server 176 has two T1 controllers 206 that can be configured to support ISDN PRI or channelized T1 connections. The ISDN PRI connection is the preferred configuration. This configuration of the remote office access server 176 allows users to use a single phone number to terminate either analog modem or ISDN calls.

The internal architecture of the remote office access server 176 is illustrated in FIG. 18. To enable dial-in clients to make remote asynchronous (modem) and ISDN connections (either synchronous or asynchronous) all of the interfaces shown in the diagram need to be configured.

A router section 208 of the remote office access server 176 routes packets between the serial interface(s) 210, which are configured for frame relay encapsulation, the ethernet interface 212, which may not be configured for remote office access management, and the loopback interface 214. All modem and ISDN Terminal Adapter dial-in users are assigned IP addresses on the network defined by the ethernet interface 212. The loopback interface 214 has the IPX network assigned to dial-in users. This configuration makes abbreviated use of the loopback interface 214. Typically, the loopback interface 214 has the following four types of neighboring interfaces used for dial-in operations: ISDN interface 216, dialer interface 218, group asynchronous interface 220 and asynchronous interface 222. Each of these interfaces will be discussed in more detail below.

The remote office access server 176 also contains a call switching module 224 that is implemented using a TDM bus. This module 224 decides for each incoming call whether to use an asynchronous (modem) interface 222 or ISDN interface 216 to handle the call's PPP or ARA frames. Finally the remote office access server 176 contains two T1 controllers 206 than are configured for ISDN PRI operation.

Configure the ISDN Switch Type

ISDN supports a number of service provider switches. To configure the ISDN switch type for the remote office access server 176, select the service provider switch type from the choices listed in Table 3.

TABLE 3
ISDN Service Provider Switch Types

| Keyword | Switch Type |
|---|---|
| basic-5ess | AT&T basic rate switches |
| basic-dms 100 | NT DMS-100 basic rate switches |
| basic-ni 1 | National ISDN-1 switches |
| primary-4ess | AT&T 4Esecurity server switch type for the U.S. |
| | (ISDN PRI only) |
| primary-5ess | AT&T 5Esecurity server switch type for the U.S. |
| | (ISDN PRI only) |
| primary-dms 100 | NT DMS-100 switch type for the U.S. (ISDN PRI |
| | only) |

Enter the configuration command in global configuration mode.
isdn switch-type switch-type

If the remote office access server 176 has two PRIs attached, they both must originate from the same switch type.

Configure Channelized T1 Controllers

Next configure the channelized T1 controllers 206. The T1 controllers 206 accept and send incoming and outgoing calls through ISDN PRI interfaces. A typical T1 controller is configured using the following commands.

controller T1 0

framing esf

linecode b8zs

clock source line primary

Pri-group timeslots 1-24

fdl ansi

The significance of each T1 controller configuration command is explained below. The first command enables the T1(0) controller. It is entered in global configuration mode. The subsequent commands define parameters for this T1 controller. These commands must be repeated to enable the other (T1) controller. The second command sets the T1 framing type. It must match the telco configuration. The third command sets the T1 line code type. It must match the telco configuration. The fourth command identifies this T1 to server as the primary or most stable clock source line. The other T1 line is configured as the secondary clock source line. The fifth command configures all 24 channels for ISDN PRI. This is the recommend configuration for remote office access management. The sixth command sets the facilities data link exchange standard for the CSU built into the T1 controller. This setting must match the telco configuration.

In accordance with a preferred embodiment, the foregoing commands configure the T1 controller 206 number 0 in FIG. 18.

The corresponding commands for T1 controller number 1 in this preferred embodiment are as follows:

controllerT1 1

framing esf

linecode b8zs

clock source line secondary

Pri-group timeslots 1-24

fdl ansi

The only changes are in line numbers 1 and 4. If the remote office access server 176 has only one PRI facility attached, it is recommended that the unused controller be shutdown.

Configure the ISDN D-Channel Serial Intefaces

When the T1 controllers 206 are configured, the corresponding ISDN D-channel serial interfaces are created. As used herein, serial interface 0:23 refers to the D channel for the T1(0) controller and serial interface 1:23 refers to the D channel for the T1(1) controller. A T1 controller 206 can be named either T1(0) or T1(1). The serial number interface 0:23 may be configured using the following commands.

interface Serial 0:23

isdn incoming-voice modem

ip unnumbered Ethernet 0

ip tcp unnumbered Ethemet0

ip tcp header-compression passive

encapsulation ppp

autodetect encapsulation ppp v120

no peer default ip address

dialer rotary-group 1

dialer idle-timeout 3600

The significance of each D-channel serial interface configuration command is explained below:

Line 1. This command is entered in global configuration mode and begins interface configuration mode for the Serial 0:23 interface. The subsequent commands define parameters for this interface. These commands must be repeated to configure the other D-channel interface (interface Serial 1:23)

Line 2. This command enables incoming ISDN voice (modem) calls to access the remote office access server call switch module and integrated modems. Incoming ISDN digital calls are unaffected by this command. ISDN digital calls directly connect to network resources even when the no isdn incoming-voice modem command is configured.

Line 3. This command enables IP processing on this dialer interface without assigning an explicit IP address to this interface. This is the same command that was used in the Group-Async interface.

Line 4. This command compress the headers of TCP/IP packets in order to reduce the size of the packets.

TCP header compression is supported on serial lines using PPP encapsulation. This is the same command that was used in the Group-Async interface.

Line 5. This command configures the frame encapsulation expected on the ISDN line.

Line 6. This command allows the detection of V.120 frames on the ISDN line when support ISDN terminal adapters/routers give the wrong isdn bearer type. This command does not enable support for V.120 calls—this is done by the vty global commands that are described elsewhere in this document.

Line 7. This command allows the dialer interface to be is put into network mode using the next free address that is in the default pool. As part of the PPP IPCP negotiation, an IP address from the pool will be offered to the remote PPP client end. If the remote PPP client wants to assign the IP address to it's end, the command async dynamic address is required, and should be added to the list of configuration commands for the dialer interface.

Line 8. Using the interface Dialer command (from global configuration mode) creates a dialer interface to which other interfaces are associated as members using the dialer rotary-group command. This one-to-many configuration allows you to configure all associated member interfaces by entering one command on the group master interface, rather than entering this command on each individual interface.

Line 9. This command sets the idle timer to 3600 seconds (1 hour). When the configuration has been idle for this amount of time, the connection is dropped. The definition of idle (ie. the interesting packets that will reset the timer) is in the dialer-list specified by the dialer-group number. The D-channel for the second PRI may be configured with a similar set of commands.

interface Serial 1:23

isdn incoming voice modem

ip unnumbered Ethernet 0

ip tcp header-compression passive

encapsulation ppp

autodetect encapsulation ppp v120

no peer default ip address

dialer rotary-group 1

dialer idle-timeout 3600

Notice line number 1 above specifies the D-channel for the second PRI. This interface is also added to the Dialer Rotary—group interface using the command in line number 8.

Creating Interfaces for Asynchronous and ISDN Dial-in Methods

The following sections show the interface configuration for the asynchronous (modem) and dialer (ISDN) interfaces. These interfaces are responsible for terminating the client's PPP and delivering packets to the remote office access server's router module 208. These interfaces also receive packets from the routing module 208 and encapsulate them in PPP for transport to the client.

Configuring the Loopback, Ethernet and Serial Interfaces

The ethernet interface 212 is used to create a “stack” of cooperating remote office access servers 176. For users that need more than 46 ports, additional remote offices can be configured on ISDN PRI lines in a single hunt group to handle all user calls. These remote office access servers 176 use the ethernet interface 212 for multi-chassis multilink PPP calls. Another use of the ethernet interface 212 is for a local LAN to access the remote office access management security server 178. There may be in the future a remote office access management security server 178 at every remote office access management point-of-presence. The communication service provider provides the remote office access management WAN data link to the customer's LAN. The remote office access management equipment is installed in the communication service provider switch room. It may be necessary to locate the security server 178 in the same switch room so that the authentication traffic does not cross LATA boundaries. A final use of the ethernet interface 212 may be for maintenance access. The communication service provider's network operations center may use a PVC on the frame relay interface for maintenance access. Therefore the ethernet port 212 is not configured for single remote office access server installations.

The loopback 0 interface 214 is a virtual IP interface carrying all the dial-in users and it exists only in remote office access server 176. An IP network number is assigned to the loopback interface, then, each asynchronous interface 222 and dialer interface 218 borrows this network number. To configure the loopback interface 214, the following commands may be used:

interface Loopback 0

ip address A.B.C.D 255.255.255.0

ipx network network

The command in line number 1 is entered from global configuration mode. The loopback interface 214 typically holds the IP address that is in the remote office access management customer's IP address space. If IPX routing is desired, the IPX network number on this interface must be unique in the remote office access management customer's network.

If the ethernet interface 212 0 needs to be configured, assign an IP address and subnet mask for the network that will connect multiple remote office access servers 176. The following commands may be used.

interface Ethernet 0

ip address A.B.C.D 255.255.255.0

The command in line number 1 is entered from global configuration mode. The ethernet interface 212 typically holds an IP address that is in the communication service provider's address space.

IP Address Strategy

Remote office access management customers will be connecting to the remote network with the expectation that they will be connected to their corporate network. Remote office access management is a remote node service. The remote office access management customer can run software applications on the remotely connected PC and the application will not know that the network connection is remote rather than local. For IP applications, this means that the IP address the remote office access management customer while remotely connected “looks” like the IP address used in the office location. This is a loose way of saying that the IP address used by remote connections must be derived from the customer's IP address space. The customer's IP address space may contain the private address space reserved by the Internet Assigned Numbers Authority (IANA) as described in RFC 1918. The following three blocks of the IP address space have been reserved for private internets:

| IP Address Book | Network Mask |
|---|---|
| 10.0.0.0- | (10/8 prefix) |
| 10.255.255.255 | |
| 172.16.0.0- | (172.16/12 prefix) |
| 172.31.255.255 | |
| 192.168.0.0- | (192.168/16 prefix) |
| 192.168.255.255 | |

Similarly, the IPX network number used by the remote user must be compatible with the IPX networks used in the customer's corporate network. The data in Table 2 needs to be supplied by the customer.

| Description | Item | Quantity |
|---|---|---|
| Router at user end of | IP Addresses | 1 |
| frame relay link | | |
| | IPX Network Number | 1 |
| | Appletalk Cable Range | 1 |
| remote office access | IP Address | One per PRI DSO call |
| manager access server | | channel + 2 |
| | IPX Network number | One per PRI DSO call |
| | | channel + 1 |
| | Appletalk Cable Range | To be determined |

The recommended way to manage these IP addresses in the remote office access server 176 is to create an IP address pool that exists inside the remote office access server 176. For this example, the name of the address pool is default and the address range is 172.16.254.1 to 172.16.254.48.

ip local pool default 172.16.254.1 172.16.254.48

This pool is created on the same IP subnet as the loopback interface 0 214. Addresses from this pool will be used for the client end of PPP connections from either modem or ISDN calls. The interface configurations below will use this pool. There are other possibilities for client end IP address assignment. The remote office access manager customer may want to use a Dynamic Host Configuration Protocol (“DHCP”) server or the customer may want to assign addresses based on the caller ID. To use the DHCP proxy-client feature, enable the remote office access server 176 to be a proxy-client on asynchronous interfaces by using the ip address-pool dhcp-proxy-client command. To specify which DHCP servers are used on the network, use the ip dhcp-server command to define up to ten specific DHCP servers.

Configure the Group Async Interface 220

The group asynchronous interface 220 is the parent interface that applies specified protocol characteristics to the asynchronous (modem) ports 222. To create a group asynchronous interface 220, the following commands may be used.

Interface Group-Async 1

ip unnumbered Loopback 0

ip tcp header-compression passive

encapsulation ppp

async mode interactive

ipx ppp-client loopback0

peer default ip address pool default

ppp authentication chap pap

group-range 1 46

The significance of each Group-Async interface 220 configuration command is explained below.

Line 1. Using the interface group-async command (from global configuration mode), create a single asynchronous interface to which other interfaces are associated as members using the group-range command. This one-to-many configuration allows the configuration of all associated member interfaces by entering one command on the group master interface, rather than entering this command on each individual interface.

Line 2. This command enables IP processing on this asynchronous interface without assigning an explicit IP address to the interface. Whenever the unnumbered interface generates a packet (for example, for a routing update), it uses the address of the loopback 0 interface as the source address of the IP packet. The loopback 0 interface IP address will be the IP address of the remote end (from the client's point of view) of all the PPP connections. Without this command, a separate IP address would be needed for each end of all the PPP connections. The unnumbered “trick” cuts the number of IP address required in half.

Line 3. This command compresses the headers of TCP/IP packets in order to reduce the size of the packets. TCP header compression is supported on serial lines using PPP encapsulation. The remote client must enable compression on its end of the PPP link. RFC 1144 specifies the compression process. Compressing the TCP header can speed up Telnet connections dramatically. This feature only compresses the TCP header, so it has no effect on UDP packets or other protocol headers.

Line 4. This command configures the frame encapsulation expected on the serial line.

Line 5. This command specifies that the asynchronous interface may be used for PPP or for ARA connections. If only PPP connections are desired, the command should be async mode dedicated The dedicated form of this command will only allow PPP connections.

Line 6. To enable a non-routing IPX client to connect to an asynchronous interface, the interface is associated with a loopback interface configured to run IPX. To permit such connections, use the ipx ppp-client interface configuration command. A loopback interface is configured with a unique IPX network number. The loopback interface is then assigned to an asynchronous interface which permits IPX clients to connect to the asynchronous interface.

Line 7. This command allows the asynchronous interface to be is put into network mode using the next free address that is in the default pool. As part of the PPP IPCP negotiation, an IP address from the pool will be offered to the remote PPP client end. If the remote PPP client wants to assign an IP address to it's end, the command async dynamic address is required, and should be added to the list of configuration commands for the group-async interface. The address the PPP client assigns should be configured in the TACACS+ security server and given to the remote office access server via TACACS+ authorization.

Line 8. This command enables CHAP or PAP so that the remote office access server requires a password from the remote device. If the remote device does not support CHAP or PAP, no traffic is passed to that device. Spaces and underscores are generally not allowed in passwords. The actual authentication is done by the remote office access manager security server. The remote office access manager user's ID and password are passed to the security server using the TACACS+protocol and the server's reply determines if the remote office access server accepts the connection. Obviously, this command is critical to maintaining the security of the user's network. Without this command, no authentication will be done and anyone who dials the PRI's telephone number will be connected to the remote office access manager user's network.

Line 9. This commands specifies the range of asynchronous interfaces that are associated with the group-async interface. Typically all async interfaces are included in a single group-async interface. If only one PRI is configured in the remote office access server, the range 1-23 is more appropriate.

Configure the ISDN Dialer Interface 218

The ISDN dialer interface 218 is the parent interface that holds the central protocol characteristics for the two ISDN D-channels that are part of dialer rotary-group 1. To configure the ISDN dialer interface 218, the following commands may be used.

interface Dialer 1

ip unnumbered Loopback 0

encapsulation ppp

autodetect encapsulation ppp

ipx network network

peer default ip address pool default

dialer in-band

dialer idle-timeout 3600

dialer-group number

no fair-queue

ppp multilink

ppp authentication pap chap

The significance of each Dialer interface 218 configuration command is explained below.

Line 1. Using the interface Dialer command (from global configuration mode) creates a dialer interface to which other interfaces are associated as members using the dialer rotary-group command. This one-to-many configuration allows the configuration of all associated member interfaces by entering one command on the group master interface, rather than entering this command on each individual interface

Line 2. This command enables IP processing on this dialer interface without assigning an explicit IP address to the interface. This is the same command that was used in the Group-Async interface.

Line 3. This command configures the frame encapsulation expected on the ISDN line.

Line 4. Use this command to enable the ISDN dialer interface to accept calls and dynamically change the encapsulation in effect on the interface when the remote device does not signal the call type. For example, if an ISDN call does not identify the call type in the Lower Layer Compatibility fields and is using an encapsulation that is different from the one configured on the interface, the interface can change its encapsulation type on the fly. This command enables interoperation with ISDN terminal adapters that use Recommendation V.120 encapsulation but do not signal V.120 in the call set message. An ISDN interface that by default answers a call as synchronous serial with PPP encapsulation can change its encapsulation and answer such calls. This description is what happens in the serial 0:23 interface. The autodetection in the ISDN dialer interface facilitates the handoff of synchronous PPP calls from the serial 0:23 interface. Automatic detection is attempted for the first 10 seconds after the link is established or the first five packets exchanged over the link, whichever is first.

Line 5. This command enables IPX routing on the interface. The IPX network number configured must be unique on the remote office access management customer's network. This network number will be assigned to the client PPP interface as part of the PPP IPXCP negotiation.

Line 6. This command allows the dialer interface to be is put into network mode using the next free address that is in the default pool. As part of the PPP IPCP negotiation, an IP address from the pool will be offered to the remote PPP client end. If the remote PPP client wants to assign an IP address to its end, the command async dynamic address may be used, and should be added to the list of configuration commands for the dialer interface.

Line 7. This commands defines a dialer access group. The dialer-list command associates in access list with a dialer access group. Packets that match the dialer group specified are considered interesting and reset the connection timer. In addition to resetting the connection timer, the access list controls what packets are passed on the interface. Therefore it is important that the access list be configured correctly.

Line 8. This command sets the idle timer to 3600 seconds (1 hour). When the connection has been idle for this amount of time, the connection is dropped. The definition of idle (i.e. the interesting packets that will reset the timer) is in the dialer-list specified by the dialer-group number.

Line 9. This command defines the dialer-list for interesting packets on this interface. There needs to be a corresponding dialer-list number global command(s).

Line 10. This command disables weighted fair queueing for the dialer interface. Fair queueing is disabled automatically on interfaces configured with the ppp multilink command.

Line 11. This command enables multilink (RFC 1717) on this interface.

Line 12. This command enables CHAP or PAP so that the remote office access server requires a password from remote device. If the remote device does not support CHAP or PAP, no traffic is passed to that device. Spaces and underscores are not allowed in passwords. The actual authentication is done by the remote office access manager security server. The remote office access manager user's ID and password are passed to the security server using the TACACS+ protocol and the server reply determines if the remote office access server accepts the connection.

Configuring Modem Lines 224

The remote office access server 176 contains integrated modems, such as V.34 modems, that may be manageable or nonmanageable. Each manageable modem has one out-of-band port, which is used for polling modem statistics and creating a directly connected session for transmitting attention (AT) commands. Nonmanageable modems do not have out-of-band ports. The remote office access servers 176 have manageable modems. The modems preferably support the latest ITU-T Recommendation for communications over the PSTN (currently Recommendation V.90). Accordingly, it is envisioned that the modems will support the 56 kbps standard that is being developed by the IT-T and which is commonly referred to as “v.pcm.”

Enable PPP on VTY Lines for Asynchronous Access over ISDN

A router may be configured to support asynchronous access over ISDN by globally enabling PPP on VTY lines. PPP is typically enabled on synchronous or asynchronous serial interfaces; however, the remote office access server software permits you to configure PPP on virtual terminal (VTY) lines. This configures the VTY line to support asynchronous access over ISDN from an ISDN terminal to a VTY session on the router. When an incoming asynchronous ISDN call is detected, as when the V.120 rate adaptation protocol is used, the remote office access server 176 will perform a protocol translation of the V.120 back to asynchronous characters so the VTY lines can be used to method the call.

To enable asynchronous protocol features on all the router's VTY lines, the following task may be performed in global configuration mode:

vty-async

vty-async dynamic-routing

vty-async header-compression

vty-async ipx ppp-client Loopback0

Configuring Security

This section covers security for the remote office access server 176. One important purpose of the remote office access server 176 is to accept calls from the telephone network interface, authenticate the user and then connect the user to the customer network. This is the authentication part of the “AAA” (Authentication, Authorization and Accounting) security scheme.

Configuring Dial-in Methods security

After the remote office access management customer dials the remote office and connects via either a modem or ISDN B-channel, the remote office access management customer must authenticate himself or herself. In accordance with the preferred embodiments of the present invention, the remote office access management apparatus offers the user two options—either a reusable password or a one-time (token) password. The majority of remote office access manager users will use a reusable password. This is a secret password that only the user knows and provides to the remote office access server as proof of their identity. The remote office access manager customer also has a name (user name) that is used for identification and it is the combination of user name and password that typically authenticates the caller. Remote office access management customers who have a token generating device, such as a Security Dynamics SecurID card, use the current token displayed on the card as the password. Other types of token cards require the user to enter a challenge (a random number) that is presented after connection and encrypt this number using the token card. The encrypted challenge, the response, is then used as the password. These authentication schemes may require different configurations on the remote office access server 176.

Authentication

User authentication collects the user name and password pair from the user and presents this data to the security server 178 for validation. There are two ways to collect this data from the remote office access manager user.

1. Use a TTY session after dial in, or

2. Use PAP or CHAP after the PPP LCP is complete and before NCP starts.

Each of these methods requires slightly different remote office access server 176 configuration commands. While the remote office access manager user may request either method to collect the user name and password data, it is recommended that the TTY session only be used for users with token authentication requirements. Using the PAP/CHAP mechanism available in PPP allows a simpler configuration for the user's PPP client.

Here are the remote office access server 176 configuration commands common to both data collection schemes.

aaa new-model

tacacs-server host A.B.C.D.

tacacs-server key word

The significance of each configuration command is explained below.

Line 1. This command is entered in global configuration mode and enables TACACS+ authentication for the remote office access server.

Line 2. This command identifies the TACACS+ security server to contact for all authentication requests. The IP address of the security server is supplied for the A.B.C.D. More than one of these commands can be used to specify alternate (backup) TACACS+ security servers.

Line 3. This command gives the key used to encrypt all data transmitted between the remote office access server and the security server. This key “word” is also entered into the security server database and must be coordinated with the security server administrator.

PAP or CHAP in PPP

This method of requesting the user name and password data from the user needs an authentication method defined for the PPP method. Here is a suggested command.

aaa authentication ppp default if-needed tacacs+

This command is entered in global configuration mode and enables TACACS+ authentication for the PPP method. An authentication list named “default” is created for the PPP method. The list is the list of authentication methods to try. The first method says not to attempt authentication if this call is already authenticated. This is important since authentication can occur in a TTY session. The next (and last) method is tacacs+ which means try the security server 178.

If the user name and password data is collected only in the PPP session, then it is recommended that the asynchronous interfaces be configured for dedicated mode. If the user name and password data is collected in TTY mode or if the remote office access management customer is using ARA, then the asynchronous interfaces should be configured for interactive mode.

This method of requesting the user name and password data from the user needs an authentication method defined for the login method. Here is a suggested command.

Aaa authentication login default tacacs+ enable

This command is entered in global configuration mode and enables TACACS+authentication for the login method. An authentication list named “default” is created for the login method. This list is the list of authentication methods to try. The first method says to use TACACS+, which means try the security server 178. Since the remote office access server operations manager also uses the login method when using telnet to access the remote office access server 176, a problem with the security server 178 would prevent any logins. Hence, the last method is “enable,” which says to accept the configured enable secret for login authentication.

The user must be able to start a login session. Configuring the client PPP dialer to open a TTY “window” after dial-in gives the user an opportunity to start a login session with the remote office access server 176. The user hits the “return” key to “wake up” the remote office access server 176. The asynchronous mode must be interactive and the line must be configured for autoselect for the remote office access server 176 to recognize the “return” key. Here are the line configuration commands.

autoselect arap

autoselect ppp

arap enable

arap timelimit 240

arap warningtime 10

autocommand ppp default

These commands are entered in line configuration mode. Lines 1-24 or 1-48 are selected.

Line 1. This command allows the client to start ARA. If this user's remote office access server is not configured for AppleTalk, then skip this command.

Line 2. This command allows the client to start PPP. The remote office access server will start a PPP server for the client only if it “sees” a PPP frame coming from the client.

Line 3. This command allows the client to start ARA. If this user's remote office access server is not configured for AppleTalk, then skip this command.

Line 4. This command sets the time out for the ARAP session inactivity timer.

Line 5. This command sets the warning time for the ARAP session inactivity timer. If this user's remote office access server is not configured for AppleTalk, then skip this command.

Line 6. This command starts the remote office access server PPP server after the login session ends. This command is very important as it provides extra security and the remote office access manager user will not see the router prompt. The default parameter on the commands means that the default IP address for the connections should be assigned.

Collecting the authentication data using a TTY login session requires more configuration commands on the remote office access server 176. The advantage of this mode is that the security server 178 can carry on a conversation with the user as part of soliciting data. This is important when the time synchronization for the SecurID card needs to be adjusted—called next pin mode; or when a user initializes his/her SecurID card—called new pin mode. In these cases, the remote office access server 176 is just a conduit for the question/responses that occur between the user and the security server 178.

Authorization

Authorization refers to the destinations that can be reached once a user has authenticated. Essentially, the remote office access server's router can install an access list for the particular interface. The access list will restrict the destinations that can be reached on the remote office access management customer's LAN. This access list is stored and configured into the security server database.

Accounting

The accounting part of AAA collects data that can be used for reports. The following accounting commands are recommended.

aaa accounting exec start-stop tacacs+

aaa accounting commands 15 start-stop tacacs+

aaa accounting network start-stop tacacs+

aaa accounting connection start-stop tacacs+These commands are entered in global configuration mode. Each command uses the start-stop keyword to generate an accounting record for the start as well as the stop of the activity. All accounting commands send their results to the TACACS+ security server 178.

Line 1. This command runs accounting for user login sessions.

Line 2. This command runs accounting for all commands at or below privilege level 15. This turns on accounting for essentially all commands.

Line 3. This command runs accounting for network related methods such as PPP and ARAP.

Line 4. This command runs accounting for all connections.

Miscellaneous Global Configuration Commands

To allow all IP and IPX traffic to pass through the dialer interface, use:

dialer-list 1 protocol ip permit

dialer-list 1 protocol ipx permit

To define a default gateway for the remote office to use as no routing is active, use:

ip route 0.0.0.0.0.0.0.0. next-hop

As described above, the remote office access manager provides remote office users with dial up access to a private data network using ordinary telephone lines, ISDN or cellular. Connectivity to the private Local Area Network (LAN) is completed by utilizing remote office access servers 176 and Frame Relay or Switched MultiMegabit Data Services (SMDS). Remote users then become part of the data network.

The generic remote office access manager diagram (FIG. 1), and the associated steps set forth below illustrate a typical remote office access management end user connection through the network.

In accordance with a preferred embodiment of the present invention, the following method is performed using the network shown in FIG. 2. First the remote office user dials into the remote office access manager network by dialing a number associated with the remote office access server 176. When a connection is established, remote office access server 176 takes the first packet and passes it to a remote office access manager security server 178. The security server 178 looks at the user information, authenticates it and approves or denies access, passing this information back to the remote office access server 176. If authorized by the security server 178, the remote office access server 176 accepts the authentication and permits the frame to pass. The information frame is passed through the frame relay network to the customer LAN 174.

The user has the following system security options.

For the following situations, the use of an aggregation router is recommended: Multi-Chassis, Multi-Link PPP and Static IP (Fixed IP address per remote client ID).

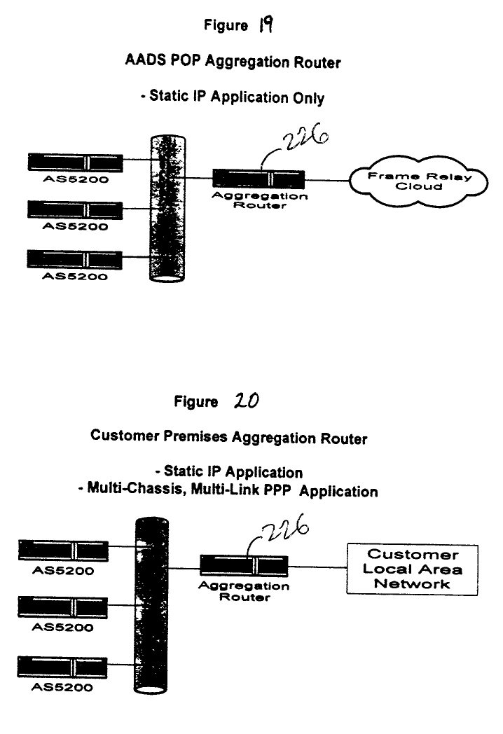

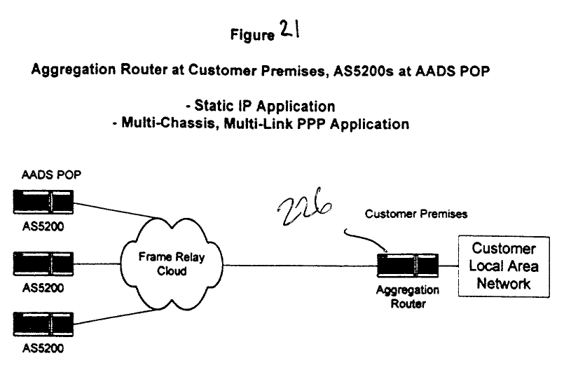

FIGS. 19, 20 and 21 illustrate examples of possible uses of an aggregation router 226 in a remote office access manager design. Note: These illustrations do not depict the entire remote office access manager architecture, only the use of an aggregation router 226. Aggregation routers 226 should be robust. A Cisco 4700, available from Cisco Systems, Inc., or better is recommended.

The circuits listed in the tables below are frame relay UNI's. For each new customer, the customer-specific circuits are to be installed. The infrastructure circuits may already be in place from a previous remote office access management installation. PVCs shall be provisioned.

1.Remote Office Access Manager POP WITH remote office access manager SECURITY
SERVER (remote office 's located at communication service providers switch site)

| | | | | communication | | |
|---|---|---|---|---|---|---|
| | | Cust. | Site | service providers | | |
| Circuit | Infrastructure | Specific | Name | Switch | RCKT | Description |
| 1 | | X | Each | Since non- | PVC#1: User's | Non-tariffed DSl, |
| (FR) | | | remote | tariffed, specify | LAN | hard cabled to FR |
| | | | office | FR switch site it is | PVC#2: router | switch. Net Admin |
| | | | access | located in | Primary | makes mod/port |
| | | | server | | PVC#3: router | assignments. PM |
| | | | | | Backup | coordinates install of |
| | | | | | | cable w/local ops. |
| 2 | | X | User's | When tariffed FR, | Each remote | Tariffed where |
| (FR or | | | LAN | no need to specify | office | applicable, speed of |
| SMDS) | | | | specific | | circuit determined by |
| | | | | communication | | user. Circuit may |
| | | | | service providers | | already be in place if |
| | | | | switch. For | | this is an existing FR |
| | | | | SMDS, which is | | or SMDS user. |
| | | | | non-tariffed, | | |
| | | | | specify switch | | |
| | | | | site. | | |
| 3 | | X | Each | Since non- | | Non-tariffed DS1, |
| (SMDS) | | | remote | tariffed, specify | | hard cabled to SMDS |
| Ordered | | | office | SMDS switch site | | switch. Net Admin |
| only | | | access | | | makes mod/port |
| when | | | server | | | assignments. PM |
| cust. | | | | | | coordinates install of |
| Conn. | | | | | | cable w/local ops. |
| is | | | | | | |
| SMDS | | | | | | |
| 4 | X | | communi- | Since non- | PVC·01: NMS | Non-tariffed DSO, |
| (FR) | | | cation | tariffed, specify | (MDLC1) | hard cabled to switch. |
| | | | server | FR switch site it is | PVC·02: | Net Admin makes |
| | | | | located in | communication | mod/port assignments. |
| | | | | | server Backup | PM coordinates install |
| | | | | | | of cable w/local ops. |
| 5 | X | | router | Since non- | PVC·01: Each | Non-tariffed DS0, |
| (FR) | | | | tariffed, specify | remote office | hard cabled to switch. |
| | | | | FR switch site the | PVC·02: router | Net Admin makes |
| | | | | router is located | Backup | mod/port assignments. |
| | | | | in | | PM coordinates install |
| | | | | | | of cable w/local ops. |

2. Remote Office Access Manager POP WITH SecurID (remote office 's located at
communication service providers switch site)

| | | | | communication | | |
|---|---|---|---|---|---|---|
| | | Cust. | Site | service providers | | |
| Circuit | Infrastructure | Specific | Name | Switch | RCKT | Description |
| 1 | | X | Each | Since non- | PVC#1: User's | Non-tariffed DS1, |
| (FR) | | | remote | tariffed, specify | LAN | hard cabled to switch. |
| | | | office | FR switch site it is | PVC#2: | Net Admin makes |
| | | | access | located in | communication | mod/port assignments. |
| | | | server | | service provider | PM coordinates install |
| | | | | | Primary | of cable w/local ops. |
| | | | | | PVC#3: | |
| | | | | | communication | |
| | | | | | service provider | |
| | | | | | Backup | |
| 2 | | X | User's | When tariffed FR, | Each remote | Tariffed where |
| (FR or | | | LAN | no need to specify | office access | applicable, speed of |
| SMDS) | | | | specific | server | circuit determined by |
| | | | | communication | | user. Circuit may |
| | | | | service providers | | already be in place if |
| | | | | switch. For | | this is an existing FR |
| | | | | SMDS, which is | | or SMDS user. |
| | | | | non-tariffed, | | |
| | | | | specify switch | | |
| | | | | site. | | |
| 3 | | X | Each | Since non- | | Non-tariffed DS1, |
| (SMDS) | | | remote | tariffed, specify | | hard cabled to SMDS |
| Ordered | | | office | SMDS switch site | | switch. Net Admin |
| only | | | access | | | makes mod/port |
| when | | | server | | | assignments. PM |
| cust. | | | | | | coordinates install of |
| conn. is | | | | | | cable w/local ops. |
| SMDS | | | | | | |
| 4 | X | | communi- | Since non- | PVC#l: NMS | Non-tariffed DS0, |
| (FR) | | | cation | tariffed, specify | (MDLC1) | hard cabled to switch. |
| | | | server | FR switch site it is | PVC#2: | Net admin makes |
| | | | | located in | communication | mod/port assignments. |
| | | | | | server Backup | PM coordinates install |
| | | | | | | of cable w/local ops. |
| 5 | X | | communi- | Since tariffed no | PVC #1: Each | Tariffed 56K FR |
| (FR) | | | cation | need to specify | remote office | where applicable. See |
| | | | service | specific | access server | Note 1. |
| | | | provider | communication | PVC#2: | |
| | | | | service providers | communication | |
| | | | | switch | service provider | |
| | | | | | Backup | |

3. Remote Office Access Manager POP WITH USER SECURITY SERVER (remote office 's
located at communication service providers switch site)

| | | | | communication | | |
|---|---|---|---|---|---|---|
| | | User | Site | service providers | | |
| Circuit | Infrastructure | Specific | Name | Switch | RCKT | Description |
| 1 | | X | Each | Since non- | PVC#1: User's | Non-tariffed DS1, |
| (FR) | | | remote | tariffed, specify FR | LAN | hard cabled to switch. |
| | | | office | switch site it is | | Net Admin makes |
| | | | access | located in | | mod/port assignments. |
| | | | server | | | PM coordinates install |
| | | | | | | o cable w/local ops. |
| 2 | | X | User's | When tariffed FR, | Each remote | Tariffed where |
| | | | LAN | no need to specify | office access | applicable, speed of |
| (FR or | | | | specific | server | circuit determined by |
| SMDS) | | | | communication | | user. Circuit may |
| | | | | service providers | | already be in place if |
| | | | | switch. For | | this is an existing FR |
| | | | | SMDS, which is | | or SMDS user. |
| | | | | non-tariffed, | | |
| | | | | specify switch | | |
| | | | | site. | | |
| 3 | | X | Each | Since non- | | Non-tariffed DS1, |
| (SMDS) | | | remote | tariffed, specify | | hard cabled to SMDS |
| Ordered | | | office | SMDS switch | | switch. Net Admin |
| only | | | access | site | | makes mod/port |
| when | | | server | | | assignments. PM |
| cust. | | | | | | coordinates install of |
| conn. is | | | | | | cable w/local ops. |
| SMDS | | | | | | |
| 4 | X | | communi- | Since non- | PVC#1: NMS | Non-tariffed DS0, |
| (FR) | | | cation | tariffed, specify | (MDLC1) | hard cabled to switch. |
| | | | server | FR switch site it is | PVC#2: | Net Admin makes |
| | | | | located in | communication | mod/port assignments. |
| | | | | | server Backup | PM coordinates install |
| | | | | | | of cable w/local ops. |

4. USER PREMISES POP WITH remote office access manager SECURITY SERVER (remote
office 's and remote office access manager Security Server located at user's premises)

| | | | | communication | | |
|---|---|---|---|---|---|---|
| | | User | Site | service providers | | |
| Circuit | Infrastructure | Specific | Name | Switch | RCKT | Description |
| 1 | | X | communi- | Since tariffed, no | PVC#1: NMS | Tariffed where |
| (FR) | | | cation | need to specify | (MDLC1) | applicable 56K FR |
| | | | server or | communication | PVC#2: | |
| | | | remote | service providers | communication | |
| | | | office | switch | server at remote | |
| | | | access | | office access | |
| | | | server | | manager POP | |
| | | | at user's | | PVC#3: Backup | |
| | | | site | | communication | |
| | | | | | server at remote | |
| | | | | | office access | |
| | | | | | manager POP | |

5. USER PREMISES POP WITH SecurID (remote office 's located at user's premises)

| | | | | communication | | |
|---|---|---|---|---|---|---|
| | | User | Site | service providers | | |
| Circuit | Infrastructure | Specific | Name | Switch | RCKT | Description |
| 1 | | X | communi- | Since tariffed, no | PVC#1: NMS | Tariffed where |
| (FR) | | | cation | need to specify | (MDLC1) | applicable 56K FR |
| | | | server or | communication | PVC#2: | |
| | | | remote | service providers | communication | |
| | | | office at | switch | service provider | |
| | | | user's | | Primary | |
| | | | site | | PVC#3: | |
| | | | | | communication | |
| | | | | | service provider | |
| | | | | | Backup | |

6. USER PREMISES POP WITH USER SECURITY SERVER (when the
remote office 's are located at user's premises)

| | | | | communication | | |
|---|---|---|---|---|---|---|
| | | User | Site | service providers | | |
| Circuit | Infrastructure | Specific | Name | Switch | RCKT | Description |
| 1 | | X | communi- | Since tariffed, no | PVC#1: NMS | Tariffed where |
| (FR) | | | cation | need to specify | (MDLC1) | applicable 56K FR |
| | | | server or | communication | | |
| | | | remote | service providers | | |
| | | | office at | switch | | |
| | | | user's site | | | |

The remote office access server 176 typically includes the following components.

| Part Number | Description | Qty |
|---|---|---|
| AS5248-DC | AS5201, DC, 48 Modems, Dual T1 | 1 |
| SF52AP-11.2.4P | Remote Office Series IOS Enterprise, plus | 1 |
| | Feature Set | |
| FR52-MMTL-48 | Remote Office 48-Modem Management | 1 |
| | Technology License | |
| AS52-56K-48 | 48 modem V.34+ to 56K future upgrade | 1 |
| MEM-16M-52 | Remote Office Main DRAM Upgrade (from | 1 |
| | 8 Mb to 16 Mb) | |
| MEM-16S-52 | Remote Office Shared DRAM Upgrade | 1 |
| | (from 4 MB to 16 MB) | |
| MEM-8BF-52 | Remote Office Boot Flash Upgrade (from | 1 |
| | 4 MB to 8 MB) | |
| MEM-1X16-AS52 | Remote Office System Flash Upgrade (from | |
| | 8 MB 1 to 16 MB) (Dual Bnk) | |
| CAB-V35MC | V.35 Cable, DCE, Male, 10 ft, | 1 |

For the embodiment in which the remote office access server 176 is listed at the customer premises, the following components may be used.

| Part Number | Description | Qty |
|---|---|---|
| AS5248-DC | AS5201, DC, 48 Modems, Dual T1 | 1 |
| SF52AP-11.2.4P | Remote Office Series IOS Enterprise, plus | 1 |
| | Feature Set | |
| FR52-MMTL-48 | Remote Office 48-Modem Management | 1 |
| | Technology License | |
| AS52-56K-48 | 48 modem V.34+ to 56K future upgrade | 1 |
| MEM-16M-52 | Remote Office Main DRAM Upgrade (from | 1 |
| | 8 Mb to 16 Mb) | |
| MEM-16S-52 | Remote Office Shared DRAM Upgrade | 1 |
| | (from 4 MB to 16 MB) | |
| MEM-8BF-52 | Remote Office Boot Flash Upgrade (from | 1 |
| | 4 MB to 8 MB) | |
| MEM-1X16-AS52 | Remote Office System Flash Upgrade (from | |
| | 8 MB 1 to 16 MB) (Dual Bnk) | |
| CAB-V35MC | V.35 Cable, DCE, Male, 10 ft, | 1 |

It is to be understood that both the foregoing general description and the following detailed description are exemplary and explanatory and are intended to provide further explanation of the invention as claimed. Numerous modifications and variations are possible. For example, the steps of the remote office access management methods described above may be taken in sequences other than those described and the invention may be practiced with more or fewer elements than those shown. The teachings herein are applicable to a remote access system with a security server. It is intended that the foregoing detailed description be regarded as illustrative rather than limiting. It is the following claims, including all equivalents, which are intended to define the scope of this invention.

We claim:

1. A method for remote office access management, comprising the steps of:
dialing a number associated with a remote office access server from a user at a remote location;
when a connection is established between the user and the remote office access server, passing a first packet containing user information from the remote office access server to a security server;
authenticating the user information at the security server;
returning an authentication decision from the security server to the remote office access server, wherein the authentication decision comprises at least one of granting access to the user and denying access to the user; and
when access is granted by the security server, permitting data to pass between the user and a customer network, through the remote office access server.

2. A method as claimed in claim 1, further comprising the step of configuring the remote office access server to handle different types of calls from the user.

3. A method as claimed in claim 2, wherein the call types include at least one of a cellular call, an analog call and an ISDN call.
